(19) United States
(12) Patent Application Publication
(10) Pub. No.: US 2026/0006366 A1
(43) Pub. Date: Jan. 1, 2026

(54) EARPHONES

(71) Applicant: SHENZHEN SHOKZ CO., LTD., Shenzhen (CN)

(72) Inventors: Yueqiang WANG, Shenzhen (CN); Yingying ZHANG, Shenzhen (CN); Song YOU, Shenzhen (CN)

(73) Assignee: SHENZHEN SHOKZ CO., LTD., Shenzhen (CN)

(21) Appl. No.: 19/319,778

(22) Filed: Sep. 5, 2025

Related U.S. Application Data
(63) Continuation of application No. PCT/CN2024/096476, filed on May 30, 2024.

(51) Int. Cl. H04R 1/10

(52) U.S. Cl. CPC H04R 1/1008; H04R 1/1033

(57) ABSTRACT

The present disclosure provides an earphone, which relates to the technical field of electronic devices. The earphone includes a headband assembly, a connecting assembly, and a speaker assembly; the connecting assembly includes a fixing assembly and a telescoping assembly, the fixing assembly includes a housing assembly and a locking member, the housing assembly includes a first housing and a second housing, the telescoping assembly includes a telescoping member; the housing assembly is provided with a plugging hole, the headband assembly has a plugging portion, the plugging portion is plugged within the plugging hole along a telescoping direction, the locking member is disposed to lock the first housing and the plugging portion along the telescoping direction, the second housing is provided with a first limiting portion and a second limiting portion. In the earphone provided in the present disclosure, the locking member locks the first housing and the plugging portion along the telescoping direction, the first limiting portion and the second limiting portion limit a movement of the second housing along the telescoping direction, and the second housing does not need to be provided with a connection hole. The thickness of the second housing at a junction between the headband assembly and the connecting assembly can be reduced, thereby reducing the dimension of the second housing and facilitating the miniaturization of the earphone.

### CROSS-REFERENCE TO RELATED APPLICATION

This application is a continuation of International Application No. PCT/CN2024/096476 filed on May 30, 2024, the contents of each of which are entirely incorporated herein by reference.

### TECHNICAL FIELD

The present disclosure relates to the technical field of electronic devices, and in particular relates to earphones.

### BACKGROUND

Earphones are extensively used in people's daily life, and are typically operable in conjunction with electronic devices, such as cell phones, computers, etc. The earphones enable users to listen to sounds from the electronic devices in a private manner, thereby avoiding disturbance to others. In open environments, such as collaborative office work, business meetings, sports, etc., the use of the earphones helps the users receive the sounds from the electronic devices. The earphones include a headband assembly, a connecting assembly, and a speaker assembly. The connecting assembly is connected between the headband assembly and the speaker assembly, and is configured to adjust a distance between the speaker assembly and the headband assembly, so as to satisfy wearing needs of different users. In existing technologies, screws are commonly employed to fix the headband assembly and the connecting assembly at a junction between the headband assembly and the connecting assembly. However, the screws need to be inserted into the corresponding components to a certain depth to ensure connection strength. This results in relatively large dimensions of related components at the junction between the headband assembly and the connecting assembly.

### SUMMARY

The present disclosure provides an earphone that solves a technical problem of larger dimensions of related components at a conjunction between a headband assembly and a connecting assembly.

To solve the above technical problem, the present disclosure provides, in one aspect, an earphone. The earphone comprises a headband assembly, a connecting assembly, and a speaker assembly. The headband assembly is disposed around a periphery of a top of a user's head in a wearing state and provides a clamping force. The connecting assembly includes a fixing assembly connected to the headband assembly and a telescoping assembly connected to the speaker assembly. The telescoping assembly has a telescoping direction with respect to the fixing assembly. The fixing assembly includes a housing assembly and a locking member. The housing assembly includes a first housing and a second housing, and the first housing and the second housing enclose to form a telescoping cavity. The telescoping assembly includes a telescoping member, one end of the telescoping member is slidably accommodated within the telescoping cavity along the telescoping direction, and the other end of the telescoping member is connected to the speaker assembly. The housing assembly is provided with a plugging hole, the headband assembly has a plugging portion, and the plugging portion is plugged within the plugging hole along the telescoping direction. The locking member is disposed to lock the first housing and the plugging portion along the telescoping direction, the second housing is provided with a first limiting portion and a second limiting portion. The first limiting portion is configured to limit a movement of the second housing toward a side where the headband assembly is located, and the second limiting portion is configured to limit a movement of the second housing toward a side where the speaker assembly is located.

In another aspect, the present disclosure provides an earphone. The earphone comprises a headband assembly, a connecting assembly, and a speaker assembly. The headband assembly is disposed around a periphery of a top of a use's head in a wearing state and provides a clamping force, and the connecting assembly is connected between the headband assembly and the speaker assembly. The connecting assembly includes a fixing assembly and a telescoping assembly. The fixing assembly is connected to the headband assembly, the telescoping assembly includes a telescoping member, one end of the telescoping member is connected to the fixing assembly telescopically, and the other end of the telescoping member is connected to the speaker assembly. The headband assembly includes a wire bundle. The wire bundle penetrates into the fixing assembly from a first end of the fixing assembly near the headband assembly, and penetrates out the fixing assembly from a second end of the fixing assembly near the speaker assembly. The wire bundle is electrically connected to the speaker assembly.

In further another aspect, the present disclosure provides an earphone. The earphone comprises a headband assembly, a connecting assembly, and a speaker assembly. The headband assembly is disposed around a periphery of a top of a user's head in a wearing state and provides a clamping force, and the connecting assembly is connected between the headband assembly and the speaker assembly. The connecting assembly includes a fixing assembly and a telescoping assembly. The fixing assembly is connected to the headband assembly and provided with a telescoping cavity, the telescoping assembly includes a telescoping member and at least two damping portions. One end of the telescoping member is slidably accommodated in the telescoping cavity, the other end of the telescoping member is connected to the speaker assembly, and the at least two damping portions are spaced apart on the telescoping member along a circumferential direction of the telescoping member. Each of the at least two damping portions elastically abut against a wall of the telescoping cavity in different directions.

According to some embodiments of the present disclosure, the earphones are configured such that the locking member locks the first housing and the plugging portion along the telescoping direction, thereby fixing the first housing and the plugging portion relative to each other along the telescoping direction. Furthermore, by providing the first limiting portion and the second limiting portion, the movement of the second housing in the telescoping direction is limited, thereby ensuring that the plugging portion, the first housing, and the second housing are relatively fixed in the telescoping direction. In contrast to conventional configurations in which screws are used to fix the plugging portion, the first housing, and the second housing, no connecting holes need to be opened on the second housing. As a result, the thickness of the second housing at the junction between the headband assembly and the connecting assembly can be reduced, thereby decreasing the dimension of the second housing and facilitating miniaturization of the earphones.

### BRIEF DESCRIPTION OF THE DRAWINGS

In order to more clearly illustrate the technical solutions in the embodiments of the present disclosure or the prior art, the following will briefly introduce the drawings that need to be used in the description of the embodiments or the prior art. Obviously, the accompanying drawings in the following description are merely some embodiments of the present disclosure. For those of ordinary skill in the art, other drawings may also be obtained according to these drawings without creative work.

FIG. 1 is a schematic diagram illustrating an assembly structure of an earphone according to some embodiments of the present disclosure;

FIG. 2 is a schematic diagram illustrating a disassembled structure of a headband assembly according to some embodiments of the present disclosure;

FIG. 3 is a schematic diagram illustrating a sectional structure of a headband assembly along a view angle according to some embodiments of the present disclosure;

FIG. 4 is a schematic diagram illustrating a disassembled structure of a connecting assembly according to some embodiments of the present disclosure;

FIG. 5 is a schematic diagram illustrating a disassembled structure of a speaker assembly according to some embodiments of the present disclosure;

FIG. 6 is a schematic diagram illustrating a disassembled structure of a speaker assembly and a stick microphone assembly according to some embodiments of the present disclosure;

FIG. 7 is a schematic diagram illustrating a partial sectional structure of an earphone along a view angle according to some embodiments of the present disclosure;

FIG. 8 is a schematic diagram illustrating a partial sectional structure of an earphone along a view angle according to some embodiments of the present disclosure;

FIG. 9 is a schematic diagram illustrating a sectional structure of a connecting assembly along another view angle according to some embodiments of the present disclosure;

FIG. 10 is a schematic structural diagram illustrating a wiring structure of a wire bundle of an earphone according to some embodiments of the present disclosure;

FIG. 11 is a schematic diagram illustrating a structure of a first housing along a view angle according to some embodiments of the present disclosure;

FIG. 12 is a schematic diagram illustrating a structure of a first housing along another view angle according to some embodiments of the present disclosure;

FIG. 13 is a schematic diagram illustrating a structure of a first housing along yet another view angle according to some embodiments of the present disclosure;

FIG. 14 is a schematic diagram illustrating a structure of a damping portion according to some embodiments of the present disclosure; and

FIG. 15 is a schematic diagram illustrating a structure of a pulling portion provided on a damping portion according to some embodiments of the present disclosure.

### DETAILED DESCRIPTION

The following will clearly and completely describe the technical solutions in the embodiments of the present disclosure with reference to the accompanying drawings in the embodiments of the present disclosure. In particular, it is noted that the following embodiments are used only to illustrate the present disclosure, but do not limit the scope of the present disclosure. Similarly, the described embodiments are only a part of the embodiments of the present disclosure, and not all of them. Based on the embodiments of the present disclosure, all other embodiments obtained by persons of ordinary skill in the art without making creative efforts belong to the scope of protection of the present disclosure.

In the description of the present disclosure, “plurality” means at least two, for example, two, three, etc., unless otherwise specifically limited. The terms “first,” “second,” “third” in the embodiments of the present disclosure are only used for the purpose of illustration, and are not to be construed as indicating or implying relative importance or implicitly specifying a count of technical features indicated. Thus, the limitation of “first,” “second,” “third” may expressly or implicitly include at least one such feature. All directional indications (e.g., up, down, left, right, forward, back, etc.) in the embodiments of the present disclosure are only used for explaining the relative positional relationship, movement conditions, etc., among components under a particular posture (as shown in the accompanying drawings). If particular posture changes, the directional indications also change accordingly. The terms “comprising,” “having,” and any variations thereof in the embodiments of the present disclosure are intended to cover non-exclusive inclusion. For example, a process, a method, a system, a product, or an apparatus that includes a series of steps or units is not limited to the listed operations or units, but optionally also includes operations or units that are not listed, or optionally also includes other operations or components that are inherent to those processes, methods, products, or devices.

Reference herein to the term “embodiment” means that a particular feature, structure, or characteristic described in connection with the embodiment can be included in at least one embodiment of the present disclosure. The occurrences of the term in various places in the present disclosure are not necessarily all referring to the same embodiment, nor are separate or alternative embodiments mutually exclusive of other embodiments. It is understood explicitly and implicitly by those skilled in the art that the embodiments described herein can be combined with other embodiments.

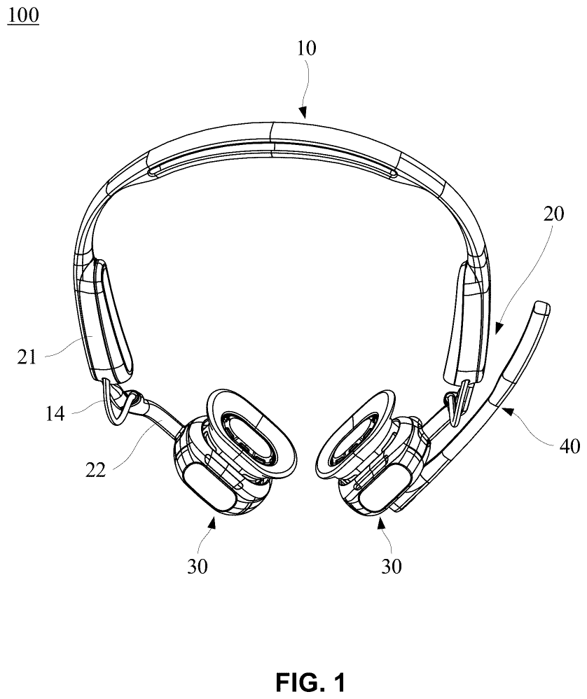

The present disclosure provides an earphone. Referring to FIG. 1, the earphone 100 may include a headband assembly 10, a connecting assembly 20, and a speaker assembly 30. The connecting assembly 20 is connected between the headband assembly 10 and the speaker assembly 30. A count of the speaker assembly 30 and a count of the connecting assembly 20 may be two. The two speaker assemblies 30 are used to transmit sounds to left and right cars of a user, respectively, and each of the two connecting assemblies 20 connects one speaker assembly 30 to one end of the headband assembly 10. The two speaker assemblies 30 may be the same or different. For example, the earphone 100 also include a stick microphone assembly 40. One of the two speaker assemblies 30 may be provided with the stick microphone assembly 40, and the other speaker assembly 30 may not be provided with the stick microphone assembly 40.

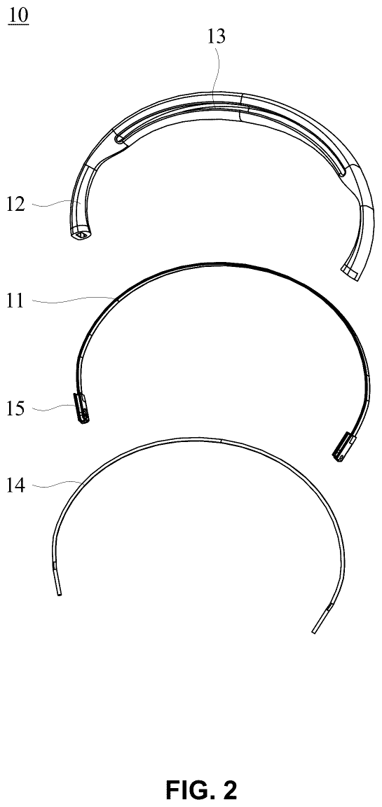

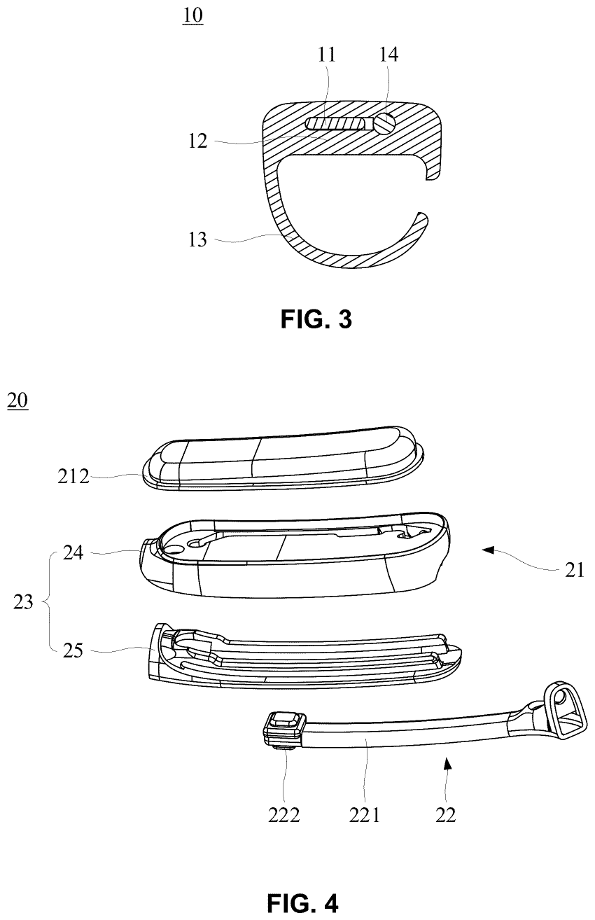

The headband assembly 10 is disposed around a periphery of a top of a user's head in a wearing state and provides a clamping force. The headband assembly 10 is used to wrap around the top of the user's head, and a shape of the headband assembly 10 may be matched with a contour of the user's head, thereby improving the comfort and stability when the user wears the headband assembly 10. The headband assembly 10 is also used to elastically clamp two sides of the user's head. Referring to FIG. 1 to FIG. 3, the headband assembly 10 may include a clamping member 11, an elastic covering body 12, an elastic abutment portion 13, and a wire bundle 14. The clamping member 11 is disposed in a curved shape along a length direction of the clamping member 11, so that the headband assembly 10 is disposed around the periphery of the top of the user's head in the wearing state and to provide the clamping force. A material of the clamping member 11 may be titanium, steel, or carbon fiber, so that the clamping member 11 has a good mechanical strength and deformation ability, thereby improving the service life of the clamping member 11. The wire bundle 14 is electrically connected to the speaker assembly 30. When the two speaker assemblies 30 are disposed, the wire bundle 14 may be connected between the two speaker assemblies 30. The wire bundle 14 is disposed along the length direction of the clamping member 11, and the elastic covering body 12 covers a periphery of the clamping member 11 and the wire bundle 14 in a molded manner, so as to cover the wire bundle 14 within the elastic covering body 12, thereby preventing the wire bundle 14 from being exposed and affecting the appearance of the earphone 100. A material of the elastic covering body 12 may be a material with elasticity, such as silicone, rubber, etc., to enhance the wearing comfort. In the wearing state, the elastic abutment portion 13 is disposed on a side of the elastic covering body 12 near the top of the head to abut against the top of the head for assisting in positioning the headband assembly 10 to the user's head. Optionally, the elastic abutment portion 13 and the elastic covering body 12 are integrally molded, thereby simplifying the processing of the headband assembly 10.

The connecting assembly 20 may be used to adjust a distance between the speaker assembly 30 and the headband assembly 10. As shown in FIG. 1 and FIG. 4, the connecting assembly 20 may include a fixing assembly 21 and a telescoping assembly 22. The fixing assembly 21 is connected to the headband assembly 10. The telescoping assembly 22 includes a telescoping member 221, one end of the telescoping member 221 is telescopically connected to the fixing assembly 21, and the other end of the telescoping member 221 is connected to the speaker assembly 30. When the telescoping member 221 moves in a telescopic motion with respect to the fixing assembly 21, since the telescoping member 221 is connected to the speaker assembly 30, the telescoping member 221 may drive the speaker assembly 30 to move in the telescopic motion with respect to the fixing assembly 21, thereby changing the distance between the speaker assembly 30 and the fixing assembly 21. The fixing assembly 21 is connected to the headband assembly 10, and the fixing assembly 21 is relatively fixed to the headband assembly 10. When a distance between the speaker assembly 30 and the fixing assembly 21 changes, the distance between the speaker assembly 30 and the headband assembly 10 changes accordingly, so that the earphone 100 may be adaptively adjusted according to a shape of the user's head when the earphone 100 is worn. Therefore, the speaker assembly 30 may be positioned in a suitable position, and the speaker assembly 30 may be in a more contact with the user's face or positioned in the car, thereby enhancing the compatibility of the earphone 100.

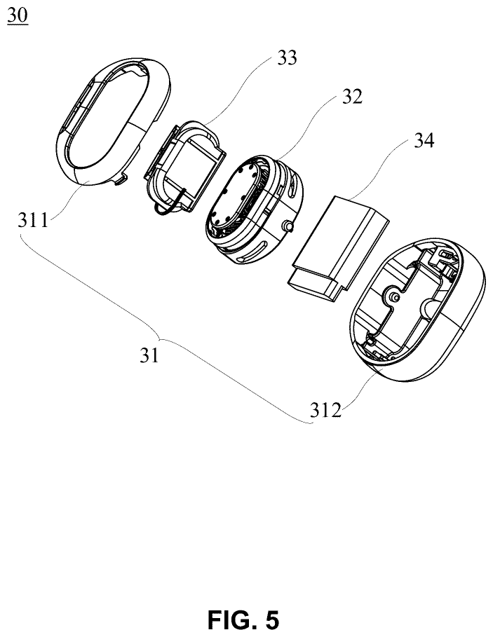

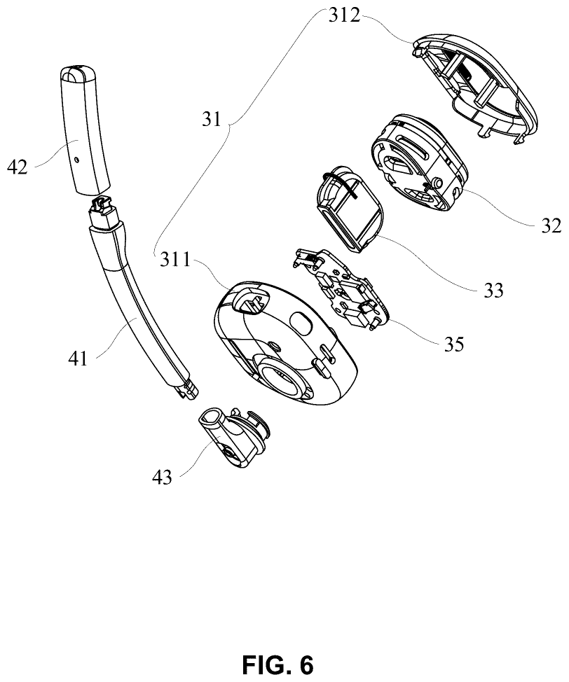

The speaker assembly 30 is used to transmit the sounds to the human car. Referring to FIG. 1, FIG. 5, and FIG. 6, the speaker assembly 30 may include at least one of a housing assembly 31, a bone conduction speaker 32, or an air conduction speaker 33. In some embodiments, the speaker assembly 30 may include one of the bone conduction speaker 32 and the air conduction speaker 33, or may be provided with the bone conduction speaker 32 and the air conduction speaker 33. The housing assembly 31 is used to accommodate at least one of the bone conduction speaker 32 or the air conduction speaker 33. The housing assembly 31 may include a main housing 311 and a main cover body 312. The main housing 311 and the main cover body 312 enclose to form a mounting space for accommodating the at least one of the bone conduction speaker 32 or the air conduction speaker 33. The at least one of the bone conduction speaker 32 or the air conduction speaker 33 converts electrical signals into mechanical vibrations in an energized state, so that the user hears the sounds through the earphone 100. The bone conduction speaker 32 contacts with the user's face, and the mechanical vibrations generated by the bone conduction speaker 32 may directly act on auditory nerve of the user based on a bone conduction principle and mainly through bones and tissues of the user as a medium. The mechanical vibrations generated by the air conduction speaker 33 may act on the tympanic membrane of the user based on an air conduction principle and mainly through the air as a medium, which in turn acts on the auditory nerve. For the sounds heard by the user, the former may be referred to as “bone conduction sounds” and the latter may be referred to as “air conduction sounds.” The speaker assembly 30 may form the bone conduction sounds or the air conduction sounds, or both the bone conduction and the air conduction sound. The speaker assembly 30 may also include at least one of a battery 34 and a control circuit board 35. The battery 34 may be used to provide electrical power when the earphone 100 operates, and the control circuit board 35 may be used to control an operating state of the earphone 100.

The stick microphone assembly 40 may be used to collect the user's voices. The stick microphone assembly 40 is disposed to the speaker assembly 30 in a rotatable manner. As shown in FIG. 6, the stick microphone assembly 40 may include a stick body assembly 41, a microphone assembly 42, and a shaft mechanism 43. The microphone assembly 42 and the shaft mechanism 43 may be connected to two ends of the stick body assembly 41, and the shaft mechanism 43 is rotatably connected to the speaker assembly 30. In the wearing state, the shaft mechanism 43 may rotate with respect to the speaker assembly 30 so as to position the microphone assembly 42 in a pickup region of the user's mouth to meet different voice collection needs.

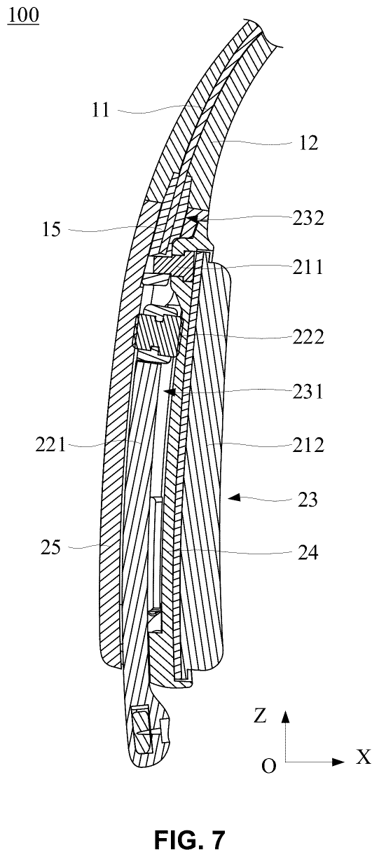

The telescoping assembly 22 has a telescoping direction with respect to the fixing assembly 21. Referring to FIG. 4 and FIG. 7, the fixing assembly 21 may include a housing assembly 23. The housing assembly 23 is provided with a telescoping cavity 231, one end of the telescoping member 221 is slidably accommodated within the telescoping cavity 231 along the telescoping direction, and the other end of the telescoping member 221 is connected to the speaker assembly 30. For instance, the telescoping direction may be a direction shown by a Z axis in FIG. 7. When the telescoping member 221 slides within the telescoping cavity 231 along the telescoping direction, the telescoping member 221 may drive the speaker assembly 30 to slide with respect to the fixing assembly 21, thereby changing the distance between the speaker assembly 30 and the fixing assembly 21. Therefore, the distance between the speaker assembly 30 and the headband assembly 10 changes accordingly, thereby adaptively adjusting the earphone 100 according to the shape of the user's head when the earphone 100 is worn.

Optionally, the housing assembly 23 is a one-piece structure. For example, the housing assembly 23 is integrally formed through an injection molding process, and the telescoping cavity 231 is formed within the housing assembly 23. The one-piece structure of the housing assembly 23 has better integrity.

In an embodiment, as shown in FIG. 7 to FIG. 9, the housing assembly 23 includes a first housing 24 and a second housing 25, and the first housing 24 and the second housing 25 enclose to form the telescoping cavity 231. For instance, the first housing 24 is provided with a first telescoping groove 246 and the second housing 25 is provided with a second telescoping groove 253. After the first housing 24 is assembled and positioned with respect to the second housing 25, the first telescoping groove 246 is in communication with the second telescoping groove 253 to enclose to form the telescoping cavity 231. By setting the housing assembly 23 as a split type, the telescoping cavity 231 is formed by enclosing the first housing 24 and the second housing 25. Therefore, the telescoping cavity 231 is formed by enclosing an open groove, thereby reducing the manufacturing difficulty of the housing assembly 23 with respect to integrally forming the housing assembly 23.

The headband assembly 10 has a plugging portion 15. The plugging portion 15 is used to connect the headband assembly 10 to the fixing assembly 21. For example, the plugging portion 15 may be connected to the housing assembly 23. The plugging portion 15 may be a portion of the clamping member 11. That is, the plugging portion 15 is integrally molded with the clamping member 11. The plugging portion 15 and the clamping member 11 may also be manufactured, respectively, and then assembled and connected. Optionally, a junction between the plugging portion 15 and the housing assembly 23 is fixed using screws. For example, the plugging portion 15 is sandwiched between the first housing 24 and the second housing 25, and the screws are threaded in a direction perpendicular to the telescoping direction through the first housing 24, the plugging portion 15, and the second housing 25 to limit movements of the telescoping direction through the first housing 24, the plugging portion 15 in the telescoping direction. In the above-described solution, the first housing 24 and the plugging portion 15 may be provided with through holes for threading the screws, and the second housing 25 may be provided with connecting holes. To prevent the screws from being exposed to affect the appearance of the earphone 100, the connecting holes may be blind holes, and to ensure the connecting strength between the screws and the second housing 25, the connecting holes on the second housing 25 need to have a certain depth. This leads to a relatively large dimension of the second housing 25 at the junction between the headband assembly 10 and the connecting assembly 20, such as a relatively thick thickness, which is not conducive to the miniaturization of the earphone 100.

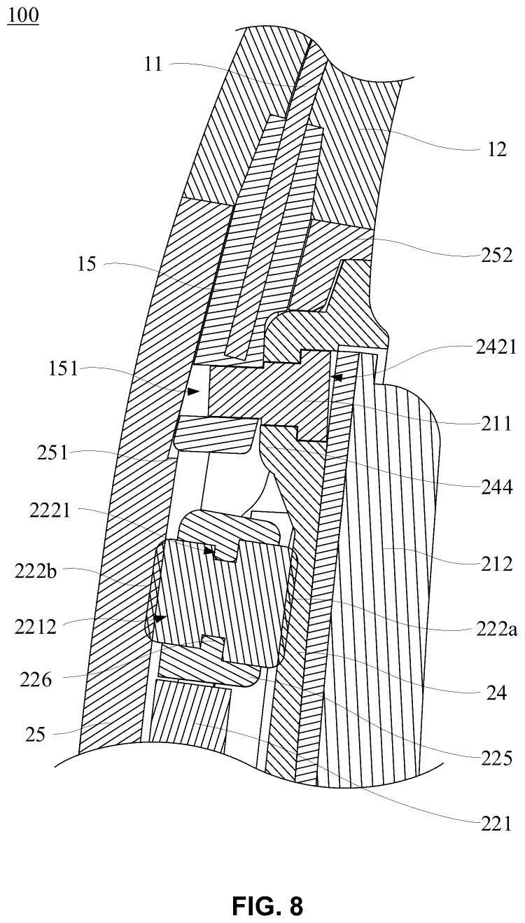

As shown in FIG. 7 and FIG. 8, the housing assembly 23 is provided with a plugging hole 232, and the plugging portion 15 is plugged within the plugging hole 232 along the telescoping direction. Specifically, the plugging hole 232 may be opened in the first housing 24 or in the second housing 25. Alternatively, grooves may be opened on the first housing 24 and the second housing 25, respectively, and the first housing 24 and the second housing 25 may enclose to form the plugging hole 232. The fixing assembly 21 includes a locking member 211, the locking member 211 is disposed to lock the first housing 24 and the plugging portion 15 along the telescoping direction, so that the first housing 24 and the plugging portion 15 are fixed relative to each other along the telescoping direction. Furthermore, the second housing 25 is provided with a first limiting portion 251 and a second limiting portion 252, the first limiting portion 251 is configured to limit a movement of the second housing 25 toward a side where the headband assembly 10 is located, and the second limiting portion 252 is configured to limit a movement of the second housing 25 toward a side where the speaker assembly 30 is located, thereby limiting the movement of the second housing 25 along the telescoping direction. In the above-described solution, the locking member 211 locks the first housing 24 and the plugging portion 15 along the telescoping direction, thereby fixing the first housing 24 and the plugging portion 15 relative to each other along the telescoping direction. Furthermore, by providing the first limiting portion 251 and the second limiting portion 252, the movement of the second housing 25 in the telescoping direction is limited, thereby ensuring that the plugging portion 15, the first housing 24, and the second housing 25 are relatively fixed in the telescoping direction. In contrast to conventional configurations in which the screws are used to fix the plugging portion 15, the first housing 24, and the second housing 25, no connecting holes need to be opened on the second housing 25. As a result, the thickness of the second housing 25 at the junction between the headband assembly 10 and the connecting assembly 20 can be reduced, thereby decreasing the dimension of the second housing 25 and facilitating miniaturization of the earphone 100.

Optionally, the locking member 211 is disposed in a form of a snap (not shown in the figure), such as a U-shaped snap. The housing assembly 23 has a first vertical direction perpendicular to the telescoping direction of the telescoping member 221. For instance, the first vertical direction is an X direction in FIG. 7. The first housing 24 and the plugging portion 15 are provided with a snap groove along the first vertical direction. After the plugging portion 15 is assembled and positioned with respect to the first housing 24, the snap is snapped in the snap groove, thereby locking the first housing 24 and the plugging portion 15 along the telescoping direction.

Referring to FIG. 8, in an embodiment, the first housing 24 is provided with a first locking hole 2421, and the plugging portion 15 is provided with a second locking hole 151. After the plugging portion 15 is assembled and positioned relative to the first housing 24, the first locking hole 2421 and the second locking hole 151 overlap with each other, the locking member 211 is inserted in the first locking hole 2421 and the second locking hole 151, and the locking member 211 cooperates with a hole wall of the locking hole. The locking member 211 may limit a relative movement between the first housing 24 and the plugging portion 15 along the telescoping direction, so as to lock the first housing 24 and the plugging portion 15 along the telescoping direction. For instance, the locking member 211 is disposed in a form of a screw or a pin, and the first locking hole 2421 and the second locking hole 151 are through holes extending through the first housing 24 and the plugging portion 15 along the first vertical direction, respectively. An inner wall of at least one of the first locking hole 2421 or the second locking hole 151 may also be provided with threads. When the locking member 211 is disposed in the form of the screw, the locking member 211, the first housing 24, and the plugging portion 15 form a threaded connection, so that the locking member 211 may also lock the first housing 24 and the plugging portion 15 in the first vertical direction. Alternatively, when the locking member 211 is disposed in the form of the pin, the locking member 211 cooperates with the wall of the at least one of the first locking hole 2421 or the second locking hole 151 in an interference fit, so that the first housing 24 and the plugging portion 15 may also be locked in the first vertical direction. By disposing the locking holes in the first housing 24 and the plugging portion 15, the locking holes can cooperate with the locking member 211 to limit the first housing 24 and the plugging portion 15 along the telescoping direction. The processing of the locking holes is relatively convenient, and the setting of the locking member 211 may be in the form of the screw or the pin, which is less costly compared to the setting of the locking member 211 in the form of the snap, and reduces the overall cost of the earphone 100.

Optionally, the first limiting portion 251 is disposed at an end of the second housing 25 near the headband assembly 10. For example, the first limiting portion 251 may be an end wall of an end of the second housing 25 near the headband assembly 10, and an outer periphery of the plugging portion 15 is provided with a flange. After the plugging portion 15 is assembled relative to the second housing 25, the flange abuts against the end wall along the telescoping direction, thereby causing the plugging portion 15 to abut against the first limiting portion 251 along the telescoping direction to limit the movement of the second housing 25 toward the side where the headband assembly 10 is located.

In an embodiment, as shown in FIG. 8, the first limiting portion 251 is disposed in a space enclosed by the first housing 24 and the second housing 25. For example, the first limiting portion 251 may be a tab or a protrusion disposed on the second housing 25 protruding toward the side where the first housing 24 is located. After the plugging portion 15 is assembled and positioned relative to the second housing 25, an end of the plugging portion 15 near the speaker assembly 30 abuts against the tab or the protrusion along the telescoping direction, thereby causing the plugging portion 15 to abut against the first limiting portion 251 along the telescoping direction to limit the movement of the second housing 25 toward the side where the headband assembly 10 is located. In the above-described embodiment, no flange needs to be disposed on the outer periphery of the plugging portion 15, thereby simplifying the processing of the plugging portion 15, and reducing the cost of the manufacturing. Furthermore, the first limiting portion 251 is disposed in the space enclosed by the first housing 24 and the second housing 25, thereby preventing the first limiting portion 251 from being exposed and affecting the appearance of the earphone 100.

Optionally, the first limiting portion 251 forms a portion of a cavity wall of an end of the telescoping cavity 231 near the headband assembly 10. When the telescoping member 221 slides within the telescoping cavity 231 toward the side where the headband assembly 10 is located, the end of the telescoping member 221 near the headband assembly 10 may abut against the first limiting portion 251, thereby limiting a telescopic travel of the telescoping member 221 toward the side where the headband assembly 10 is located. Therefore, the telescoping member 221 can not contact the plugging portion 15 when the telescoping member 221 slides, thereby preventing the telescoping member 221 from influencing the connection between the plugging portion 15 and the first housing 24 when the telescoping member 221 slides, and enhancing the reliability of the connection between the plugging portion 15 and the fixing assembly 21.

Optionally, the second limiting portion 252 is provided at an end of the second housing 25 near the speaker assembly 30. For example, the second limiting portion 252 may be an end wall of the end of the second housing 25 near the speaker assembly 30, and an end of the first housing 24 near the speaker assembly 30 is provided with a flange protruding toward the side where the second housing 25 is located. After the second housing 25 is assembled and positioned relative to the first housing 24, the flange abuts against the end wall along the telescoping direction, thereby causing the first housing 24 to abut against the second limiting portion 252 along the telescoping direction to limit the movement of the second housing 25 toward the side where the speaker assembly 30 is located.

Referring to FIG. 8, in an embodiment, the second limiting portion 252 protrudes from an exterior of the second housing 25 and at least partially overlaps with the plugging hole 232 along the telescoping direction. After the second housing 25 is assembled and positioned with respect to the first housing 24, the first housing 24 abuts against the second limiting portion 252 along the telescoping direction to limit the movement of the second housing 25 toward the side where the speaker assembly 30 is located. By disposing the second limiting portion 252 to at least partially overlap with the plugging hole 232 along the telescoping direction, the plugging hole 232 may be opened at the end of the second housing 25 near the headband assembly 10. The second limiting portion 252 is enclosed around an outer periphery of a hole wall of the plugging hole 232, and the second limiting part 252 forms a reinforcement at a place of the second housing 25 where the plugging hole 232 is opened. This can enhance the strength of the second housing 25 at the place where the plugging hole 232 is opened, and reduce the likelihood of failure in the plugging hole 232, thereby enhancing the reliability of the connection between the plugging portion 15 and the fixing assembly 21.

In an embodiment, as shown in FIG. 8, the first housing 24 is provided with a reinforcement bump 244, the reinforcement bump 244 protrudes to the side where the second housing 25 is located, and the first locking hole 2421 is opened on the reinforcement bump 244. With the arrangement, firstly, the reinforcement bump 244 forms a reinforcement at a place of the first housing 24 where the first locking hole 2421 is opened. This can enhance the strength of the first housing 24 at the place where the first locking hole 2421 is opened, and reduce the likelihood of failure in the first locking hole 2421, thereby enhancing the reliability of the connection between the plugging portion 15 and the fixing assembly 21. Further, the reinforcement bump 244 protrudes toward the side where the second housing 25 is located, so that the reinforcement bump 244 is located in the space enclosed by the first housing 24 and the second housing 25, thereby hiding the reinforcement bump 244 between the first housing 24 and the second housing 25. While forming the reinforcement at the place of the first housing 24 where the first locking hole 2421 is opened, the influence of the reinforcement bump 244 on the appearance of the housing assembly 23 can be reduced.

Optionally, the reinforcement bump 244 forms a portion of the cavity wall of the end of the telescoping cavity 231 near the headband assembly 10. When the telescoping member 221 slides within the telescoping cavity 231 toward the side where the headband assembly 10 is located, the end of the telescoping member 221 near the headband assembly 10 may abut against the reinforcement bump 224, thereby limiting the telescopic travel of the telescoping member 221 toward the side where the headband assembly 10 is located. Therefore, the telescoping member 221 can not contact the plugging portion 15 when the telescoping member 221 slides, thereby preventing the telescoping member 221 from influencing the connection between the plugging portion 15 and the first housing 24 when the telescoping member 221 slides, and enhancing the reliability of the connection between the plugging portion 15 and the fixing assembly 21. While the reinforcement bump 244 forms the reinforcement at the place of the first housing 24 where the first locking hole 2421 is opened, the reinforcement bump 244 also serves as a limiting member for the telescopic travel of the telescoping member 221 toward the side where the headband assembly 10 is located. On the one hand, a count of components of the fixing assembly 21 is reduced, thereby reducing the cost. On the other hand, compared with providing an additional limiting member for the telescopic travel of the telescoping member 221 on the side of the reinforcement bump 244 near the speaker assembly 30, a location of a maximum telescopic travel of the telescoping member 221 toward the side where the headband assembly 10 is located can be as close as possible to the headband assembly 10. Under the condition of the same telescopic travel, the internal space of the fixing assembly 21 is fully utilized, and the length of the fixing assembly 21 in the telescoping direction can be reduced, facilitating the miniaturization of the earphone 100.

Optionally, the first housing 24 and the second housing 25 are bonded to limit the relative movement between the first housing 24 and the second housing 25 in the direction perpendicular to the telescoping direction, so that the first housing 24 and the second housing 25 are not easily separated from each other in the direction perpendicular to the telescoping direction. This can prevent the second housing 25 from detaching, thereby maintaining the overall integrity of the housing assembly 23.

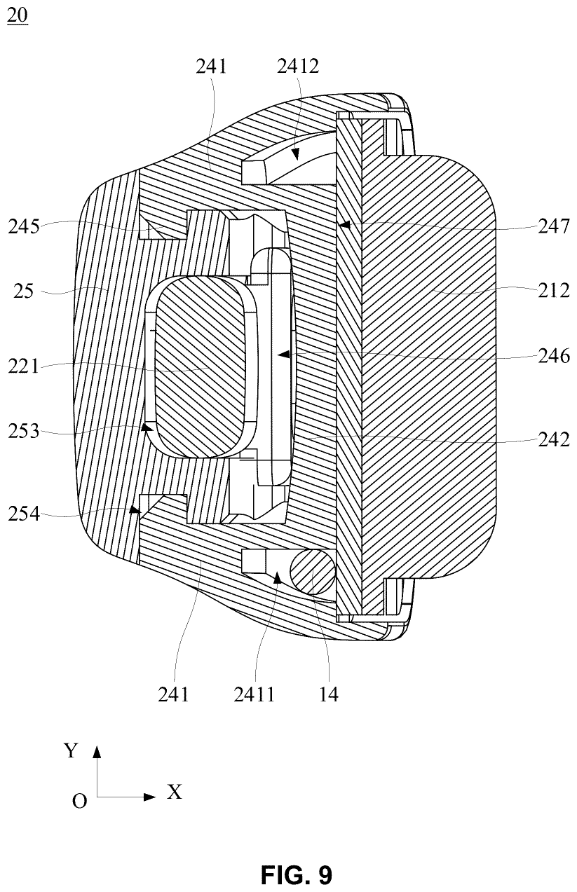

Referring to FIG. 9, in an embodiment, one of the first housing 24 and the second housing 25 is opened with a limiting slide groove 254 extending along the telescoping direction, and the other one of the first housing 24 and the second housing 25 is provided with a first limiting flange 245. That is, the limiting slide groove 254 may be opened in the second housing 25, and accordingly, the first limiting flange 245 is disposed in the first housing 24.

Alternatively, the limiting slide groove 254 is opened in the first housing 24, and accordingly, the first limiting flange 245 is disposed in the second housing 25. The following is illustrated as an example of the limiting slide groove 254 being opened in the second housing 25. The first limiting flange 245 is accommodated within the limiting slide groove 254 to allow the first housing 24 and the second housing 25 to slide relative to each other along the telescoping direction and limit the first housing 24 and the second housing 25 to separate from each other along the direction perpendicular to the telescoping direction. This can prevent the second housing 25 from detaching, thereby maintaining the overall integrity of the housing assembly 23. By disposing the first limiting flange 245 and the limiting slide groove 254, the first housing 24 and the second housing 25 can slide with each other along the telescoping direction, which is not only convenient for the assembly and connection of the first housing 24 and the second housing 25, but also convenient for disassembly and maintenance at a later stage. In addition, the relative movement between the second housing 25 and the first housing 24 in the direction perpendicular the telescoping direction can be limited.

As shown in FIG. 9, the first housing 24 has the first vertical direction and a second vertical direction, the first vertical direction is perpendicular to the telescoping direction of the telescoping member 221, and the second vertical direction is perpendicular to the telescoping direction and the first vertical direction. For instance, the first vertical direction and the second vertical direction may be an X-axis direction and a Y-axis direction as shown in FIG. 9, respectively. The first housing 24 includes two sidewalls 241 spaced apart from each other along the first vertical direction and a bottom wall 242 connecting the two sidewalls 241 along the first vertical direction. A thickness of each of the two sidewalls 241 along the second vertical direction is greater than a thickness of the bottom wall 242 along the second vertical direction so as to form the first telescoping groove 246 between the two sidewalls 241. By disposing the two sidewalls 241 and the bottom wall 242 to form the first telescoping groove 246, a side of the first telescoping groove 246 toward the second housing 25 is open. After the first telescoping groove 246 is connected to the second telescoping groove 253 opened on the second housing 25, the first telescoping groove 246 and the second telescoping groove 253 enclose to form the telescoping cavity 231. Since the side of the first telescoping groove 246 is open, the first telescoping groove 246 is easier to process than a closed groove, thereby simplifying the manufacturing process of the first housing 24.

Optionally, the first limiting flange 245 is connected to the sidewalls 241 and protrudes toward a side where the first telescoping groove 246 is located. There may be a plurality of first limiting flanges 245. For example, the plurality of first limiting flanges 245 are spaced apart along the telescoping direction, and the plurality of first limiting flanges 245 cooperate with the limiting slide groove 254 to form a multi-point limitation, thereby preventing the second housing 25 and the first housing 24 from separating from each other in the direction perpendicular to the telescoping direction. There may also be one first limiting flange 245. For example, one first limiting flange 245 extends continuously along the telescoping direction. In the telescoping direction, a length of the first limiting flange 245 is substantially equal to a length of the limiting slide groove 254. When the first housing 24 is assembled and positioned relative to the second housing 25, the first limiting flange 245 extends continuously to cooperate with the limiting slide groove 254 to form the multi-point limit, thereby preventing the second housing 25 and the first housing 24 from separating from each other in the direction perpendicular to the telescoping direction. Additionally, the continuously extending first limiting flange 245 may be scaled at a splicing seam between the first housing 24 and the second housing 25, thereby enhancing the airtightness of the telescoping cavity 231 and preventing dust from entering the telescoping cavity 231.

Optionally, the limiting slide groove 254 is opened on the side walls of the second housing 25. In the telescoping direction, one end of the limiting slide groove 254 is open, and the other end of the limiting slide groove 254 is closed. For example, an end of the limiting slide groove 254 near the speaker assembly 30 is open, and an end of the limiting slide groove 254 near the headband assembly 10 is closed, thereby assembling the first housing 24 to the second housing 25 along the telescoping direction in a sliding manner. Optionally, the second limiting portion 252 is disposed at the end of the second housing 25 near the headband assembly 10. For example, the second limiting portion 252 may be an end wall sealing the end of the limiting slide groove 254 near the headband assembly 10. After the first housing 24 is slid and positioned with respect to the second housing 25, an end of the first limiting flange 245 near the headband assembly 10 abuts against the end wall, thereby causing the first housing 24 to abut against the second limiting portion 252 along the telescoping direction to limit the movement of the second housing 25 toward the side where the speaker assembly 30 is located. By disposing the second limiting portion 252 to be the end wall scaling the end of the limiting slide groove 254 near the headband assembly 10, the count of the components on the second housing 25 can be reduced, thereby reducing the cost.

In an embodiment, the locking member 211 is disposed not to be in direct contact with the second housing 25. Optionally, the second locking hole 151 is a blind hole in the plugging portion 15 along the first vertical direction, and the second locking hole 151 does not penetrate a side of the plugging portion 15 near the second housing 25, so that the locking member 211 does not in direct contact with the second housing 25. This can reduce a depth of the second locking hole 151 on the plugging portion 15, thereby minimizing the weakening effect of the opening on the strength of the plugging portion 15, and enhancing the reliability of the connection between the plugging portion 15 and the fixing assembly 21. Alternatively, the second locking hole 151 is a through hole on the plugging portion 15 along the first vertical direction, and a length of the locking member 211 along the first vertical direction is less than a sum of lengths of the first locking hole 2421 and the second locking hole 151 along the first vertical direction. Therefore, an end of the locking member 211 near the second housing 25 does not contact with the second housing 25. This prevents the locking member 211 from contacting the second housing 25 during the assembly of the locking member 211, thereby avoiding the relative movement between the second housing 25 and the first housing 24 in the first vertical direction caused by the locking member 211.

The elastic covering body 12 may extend along the length direction of the clamping member 11 to the junction between the headband assembly 10 and the fixing assembly 21. For example, the elastic covering body 12 covers the outer periphery of the plugging portion 15. At the junction between the headband assembly 10 and the fixing assembly 21, there is a splicing scam between the elastic covering body 12 and the housing assembly 23. No elastic covering body 12 is in the splicing beam to share the force, resulting in a relatively high force on the plugging portion 15, and increasing the risk of failure. Referring to FIG. 8, in an embodiment, the plugging portion 15 is connected to an end of the clamping member 11 near the fixing assembly 21. In a reference section perpendicular to the telescoping direction, a cross-sectional dimension of the plugging portion 15 is greater than a cross-sectional dimension of the clamping member 11. This can reduce a cross-sectional force on the plugging portion 15 at the junction between the headband assembly 10 and the fixing assembly 21, reducing the likelihood of failure of the plugging portion 15. Therefore, the reliability of the junction between the plugging portion 15 and the fixing assembly 21 is enhanced.

In an embodiment, as shown in FIG. 8, the second locking hole 151 is connected to opposite sides of the plugging portion 15, and a connection region formed between the clamping member 11 and the plugging portion 15 is located outside of the second locking hole 151. This can reduce the weakening effect of the second locking hole 151 on the connection region between the clamping member 11 and the plugging portion 15, thereby ensuring the reliability of the junction between the clamping member 11 and the plugging portion 15.

Referring to FIG. 7, in an embodiment, in the wearing state, the first housing 24 is disposed near the user's head, and the second housing 25 is disposed away from the user's head. Therefore, when the first housing 24 and the second housing 25 enclose to form the telescoping cavity 231, the splicing seam between the first housing 24 and the second housing 25 avoids the side of the fixing assembly 21 that contacts the user's head. For example, the splicing scam between the first housing 24 and the second housing 25 may be located on the side of the fixing assembly 21 near the top of the head and the side of the fixing assembly 21 near the chin, thereby improving the wearing comfort of the earphone 100. A side of the first housing 24 toward the user's head is provided with a positioning groove 247, the fixing assembly 21 further includes a contact member 212, and the contact member 212 is removably disposed in the positioning groove 247. The contact member 212 is configured to abut against the user's head. With such arrangement, on the one hand, the contact member 212 can cover the outside of the locking member 211, thereby preventing the locking member 211 from being exposed on the fixing assembly 21 and affecting the appearance of the earphone 100. On the other hand, in the wearing state of the earphone 100, in addition to the speaker assembly 30 contacting the user's head, the contact member 212 also contacts the user's head, thereby increasing contact points between the earphone 100 and the user's head, and improving the comfort and stability when the earphone 100 is worn. Furthermore, the contact member 212 is detachable, which facilitates the replacement of the contact member 212. Alternatively, a plurality of sets of contact members 212 may be provided, enabling the user to choose the most comfortable contact member 212 to install into the positioning groove 247. Optionally, a material of the contact member 212 includes an elastic material. Under the clamping force of the clamping member 11, the contact member 212 may undergo a certain degree of elastic compression deformation, thereby increasing a contact area between the contact member 212 and the user's head, and further enhancing the wearing comfort of the earphone 100.

Optionally, the wire bundle 14 extends from the exterior of the fixing assembly 21 to the telescoping assembly 22 and is fixed on the telescoping assembly 22, so as to be electrically connected to the speaker assembly 30. With such arrangement, the internal space of the fixing assembly 21 occupied by the wire bundle 14 can be reduced, facilitating the miniaturization of the fixing assembly 21.

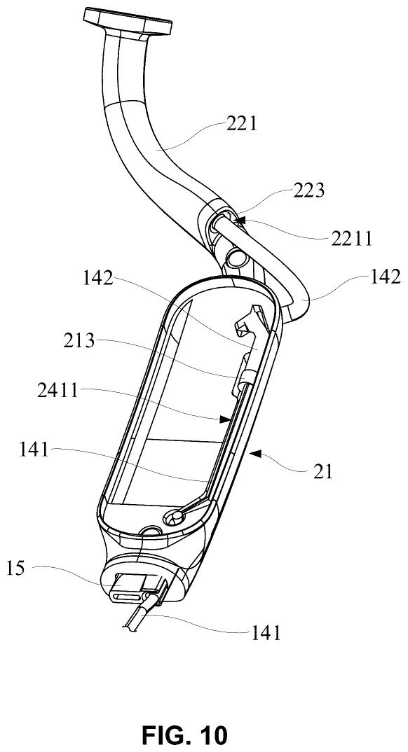

Optionally, as shown in FIG. 10, the wire bundle 14 penetrates into the fixing assembly 21 from a first end of the fixing assembly 21 near the headband assembly 10, and penetrates out of the fixing assembly 21 from a second end of the fixing assembly 21 near the speaker assembly 30, and the wire bundle 14 is electrically connected to the speaker assembly 30. With such arrangement, the wire bundle 14 can be hidden inside the fixing assembly 21, so that the wiring of the wire bundle 14 is relatively regular and the influence of the wire bundle 14 on the appearance of the earphone 100 is reduced, thereby enhancing the appearance and expressiveness of the earphone 100.

Optional, the fixing assembly 21 is provided with a wiring channel penetrating through the fixing assembly 21 along the telescoping direction of the telescoping member 221, and the wire bundle 14 is disposed in the wiring channel, thereby hiding the wire bundle 14 inside the fixing assembly 21 and reducing the influence of the wire bundle 14 on the appearance of the earphone 100. For example, the wire bundle 14 penetrates into the telescoping cavity 231 from the first end of the fixing assembly 21 near the headband assembly 10, and penetrates out the telescoping cavity 231 from the second end of the fixing assembly 21 near the speaker assembly 30, thereby hiding the wire bundle 14 inside the fixing assembly 21 through the telescoping cavity 231, and fully utilizing the space of the telescoping cavity 231 for wiring. As the telescoping member 221 is slidably accommodated within the telescoping cavity 231, to avoid interference between the telescoping member 221 and the wire bundle 14 when the telescoping member 221 moves, the telescoping cavity 231 may be provided with an isolation member to isolate the telescoping member 221 from the wire bundle 14.

Optionally, the wire bundle 14 is provided outside the telescoping cavity 231, thereby avoiding the telescoping member 221 from interfering with the wire bundle 14 when the telescoping member 221 moves. Referring to FIG. 9, the fixing assembly 21 includes the first housing 24 and the contact member 212, and the first housing 24 encloses to form at least a portion of the telescoping cavity 231. That is, in the reference section perpendicular to the telescoping direction, a projection of the telescoping cavity 231 may fully fall into the first housing 24. At this case, the first housing 24 independently encloses to form all of the telescoping cavity 231. The projection of the telescoping cavity 231 may also partially fall into the first housing 24. At this case, the first housing 24 is co-enclosed with other components to form the telescoping cavity 231. For example, the first housing 24 is co-enclosed with the second housing 25 to form the telescoping cavity 231. A portion of the wire bundle 14 located between the first end and the second end of the fixing assembly 21 is visible from the exterior of the first housing 24 and is covered by the contact member 212. With such arrangement, on the one hand, the wire bundle 14 can be set outside the telescoping cavity 231 to avoid the interference between the telescoping member 221 and the wire bundle 14 when the telescoping member 221 moves. On the other hand, the contact member 212 covers the portion of the wire bundle 14 exposed to the first housing 24, and hides the wire bundle 14 between the first housing 24 and the contact member 212. By wiring the wire bundle 14 within the space enclosed by the first housing 24 and the contact member 212, the influence of the wire bundle 14 on the appearance of the earphone 100 can be reduced.

Optionally, the portion of the wire bundle 14 exposed to the first housing 24 is affixed to a surface of a side of the first housing 24 near the contact member 212 and is fixed using adhesive tape or glue bonding, so that the wire bundle 14 is less prone to shift.

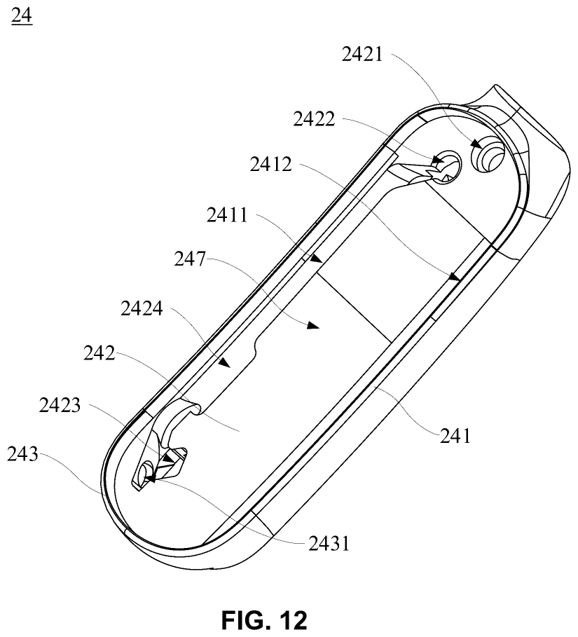

In an embodiment, as shown in FIG. 9 to FIG. 12, one side of the first housing 24 is provided with the first telescoping groove 246, and the other side of the first housing 24 away from the first telescoping groove 246 is provided with a wire groove 2411, the wire bundle 14 is embedded within the wire groove 2411, and the contact member 212 covers the wire groove 2411. By providing the wire groove 2411, on the one hand, the wire bundle 14 is embedded in the wire groove 2411, and a groove wall of the wire groove 2411 can limit a lateral displacement of the wire bundle, so that the wire bundle is less prone to shift. On the other hand, relative to the wire bundle 14 being affixed to the surface of the first housing 24, the thickness of the first housing 24 in the direction perpendicular to the telescoping direction is fully utilized to accommodate the wire bundle 14, thereby reducing the dimensions of the housing assembly 23 in the direction, and facilitating the miniaturization of the earphone 100.

In the wearing state, the contact member 212 is disposed on the side of the first housing 24 near the head, and is configured to abut against a side surface of the head to achieve an auxiliary positioning of the headband assembly 10 on the head, thereby improving the comfort and stability when the earphone 100 is worn. Specifically, in the wearing state of the earphone 100, in addition to the speaker assembly 30 contacting the user's head, the contact member 212 also contacts the user's head, thereby increasing the contact points between the earphone 100 and the user's head, and improving the comfort and stability when the earphone 100 is worn. Optionally, the material of the contact member 212 includes the elastic material. Under the clamping force of the clamping member 11, the contact member 212 may undergo the certain degree of elastic compression deformation, thereby increasing the contact area between the contact member 212 and the user's head, and further enhancing the wearing comfort of the earphone 100.

Referring to FIG. 9 to FIG. 12, the first housing 24 has the first vertical direction and the second vertical direction, the first vertical direction is perpendicular to the telescoping direction of the telescoping member 221, and the second vertical direction is perpendicular to the telescoping direction and the first vertical direction. The first housing 24 includes the two sidewalls 241 spaced apart from each other along the first vertical direction and the bottom wall 242 connecting the two sidewalls 241 along the first vertical direction, the thickness of each of the two sidewalls 241 along the second vertical direction is greater than the thickness of the bottom wall 242 along the second vertical direction so as to form the first telescoping groove 246 between the two sidewalls 241. Optionally, the wire groove 2411 is opened on the bottom wall 242. The bottom wall 242 is connected between the two sidewalls 241, so that a wiring location of the wire bundle 14 is relatively centered, the bending of the wire bundle 14 can be reduced, the length of the wire bundle 14 can be shortened, and the amount of materials can be saved.

In an embodiment, as shown in FIG. 9 to FIG. 12, at least a portion of a projection of the wire groove 2411 along the second vertical direction falls within one of the two sidewalls 241, so that the wire groove 2411 is at least partially opened on the side walls 241. A relatively large thickness of the side walls 241 in the second vertical direction can be fully utilized, thereby reducing the thickness of the bottom wall 242 in the second vertical direction, facilitating the miniaturization of the earphone 100.

Referring to FIG. 9, in an embodiment, the wire groove 2411 and a projection of the first telescoping groove 246 along the first vertical direction at least partially overlap. With such arrangement, under the condition that the dimension of the wire groove 2411 is fixed, a dimension of the side of the sidewalls 241 protruding towards the contact member 212 can be reduced, thereby reducing the dimensions of the sidewalls 241 along the second vertical direction, and facilitating the miniaturization of the earphone 100.

In an embodiment, as shown in FIG. 9 to FIG. 12, the other side of the first housing 24 away from the first telescoping groove 246 is further provided with a glue reduction groove 2412, and at least a portion of a projection of the glue reduction groove 2412 along the second vertical direction falls within the other one of the two sidewalls 241. When the wire groove 2411 is opened in one of the two sidewalls 241, the sidewall 241 has a relatively large width in the first vertical direction to accommodate the wire bundle 14. Generally, to ensure the aesthetic appearance of the first housing 24, the two sidewalls 241 can be symmetrically disposed relative to the bottom wall 242. Therefore, the width of the other sidewall 241 in the first vertical direction is comparable to the width of the sidewall 241 with the wire groove 2411 in the first vertical direction. That is, the width of the other sidewall 241 is also relatively large. By providing the glue reduction groove 2412, the wall thickness of the other sidewall 241 can be reduced, resulting in a relatively uniform wall thickness and reducing deformation during a cooling process of the injection molding.

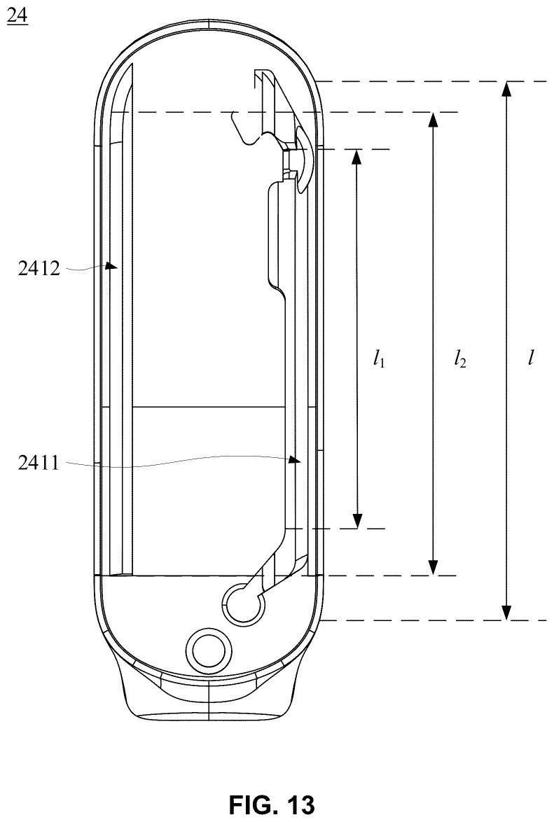

In an embodiment, along the telescoping direction, each of a length of the wire groove 2411 and a length of the glue reduction groove 2412 is not less than 50% of a length of the two sidewalls 241. As shown in FIG. 13, if the length l₁ of the wire groove 2411 is less than 50% of the length/of the two sidewalls 241, the wire bundle 14 exposed to the first housing 24 may have a relatively long length located out of the wire groove 2411, the lateral displacement of the wire bundle 14 lacks constraints, and the wire bundle 14 is prone to shift. By setting the length of the wire groove 2411 to be no less than 50% of the length of the two sidewalls 241, the wire bundle 14 visible from the outside of the first housing 24 is embedded within the wire groove 2411 as much as possible. The groove walls of the wire groove 2411 can limit the lateral displacement of the wire bundle 14, so that the wire bundle 14 is less prone to shift. If the length l₂ of the glue reduction groove 2412 is less than 50% of the length l of the two sidewalls 241, a relatively short length of the glue reduction groove 2412 on the first housing 24 may result in uneven wall thickness in some regions, thereby increasing the deformation during the cooling process of the injection molding. Optionally, each of the length of the wire groove 2411 and the length of the glue reduction groove 2412 is 60%, 70%, 80%, 90%, etc., of the length of the two sidewalls 241, which is not specifically limited herein.

Further, a length of the portion of the wire groove 2411 falling within the one of the two sidewalls 241 is not less than 50% of the length of the wire groove 2411, and a length of the portion of the glue reduction groove 2412 falling within the other one of the two sidewalls 241 is not less than 50% of the length of the glue reduction groove 2412. With such arrangement, the wire groove 2411 and the glue reduction groove 2412 are positioned on the sidewalls 241 as much as possible. By opening the wire groove 2411 on one of the two sidewalls 241, the relatively large thickness of the sidewalls 241 in the second vertical direction can be fully utilized. Compared to opening the wire groove 2411 on the bottom wall 242, the arrangement reduces the thickness of the bottom wall 242 in the second vertical direction, facilitating the miniaturization of the earphone 100. Meanwhile, by opening the glue reduction groove 2412 on the other sidewall 241 that is provided with the wire groove 2411, the wall thickness of the other sidewall 241 can be reduced, resulting in a relatively uniform wall thickness and reducing the deformation during the cooling process of the injection molding. Optionally, the lengths of the portions of the wire groove 2411 and the glue reduction groove 2412 falling within the sidewalls 241 are 60%, 70%, 80%, 90%, etc., of the length of the sidewalls 241.

Optionally, the wire groove 2411 penetrates through the first housing 24 along the telescoping direction, so that the wire bundle 14 is threaded into the first end of the fixing assembly 21 from the wire groove 2411 and out of the second end of the fixing assembly 21 from the wire groove 2411.

Referring to FIG. 9 to FIG. 12, optionally, at least one of the first housing 24 or the second housing 25 is provided with a plugging hole plugging with the headband assembly 10, and the wire bundle 14 is inserted into a space enclosed by the first housing 24 and the second housing 25 along the plugging hole 232. By threading the wire bundle 14 through the plugging hole 232, a count of openings in the housing assembly 23 can be reduced, thereby reducing the influence of the openings on the appearance of the housing assembly 23. The first housing 24 is further provided with a first wire hole 2422 near the first end of the fixing assembly 21 and connected to the wire groove 2411. The wire bundle 14 further extends through the first wire hole 2422 to the other side of the first housing 24 away from the first telescoping groove 246. By providing the first wire hole 2422, the wire bundle 14 extends through the first wire hole 2422 to the other side of the first housing 24 away from the first telescoping groove 246. On one hand, the wire bundle 14 can be located outside the telescoping cavity 231, preventing the interference between the telescoping member 221 and the wire bundle 14 when the telescoping member 221 moves. On the other hand, a hole wall of the first wiring hole 2422 can limit the lateral movement of the wire bundle 14, thereby limiting the wire bundle 14 at the point where the wire bundle 14 inserts into the fixing assembly 21. Therefore, the wire bundle 14 is relatively fixed and is less prone to shift. For instance, the first wire hole 2422 is opened on the bottom wall 242, and the first wire hole 2422 penetrates through two oppositely disposed surfaces of the bottom wall 242 along the second vertical direction. The first wire hole 2422 may be disposed adjacent to the first locking hole 2421.

Referring to FIG. 9 to FIG. 12, the first housing 24 includes two end walls 243 spacing apart from each other along the telescoping direction and connecting the two sidewalls 241. The two end walls 243, the two side walls 241, and the bottom wall 242 may be enclosed to form the positioning groove 247 for mounting the contact member 212. The first housing 24 is further provided with a second wire hole 2431 near the second end of the fixing assembly 21 and connected to the wire groove 2411. The second wire hole 2431 penetrates through at least one of the two sidewalls 241 or the end walls 243 near the second end of the fixing assembly 21. The wire bundle 14 extends toward the speaker assembly 30 through the second wire hole 2431. Specifically, the second wire hole 2431 may penetrate through the two sidewalls 241. The second wire hole 2431 may also penetrate through the two end walls 243. Alternatively, a portion of the second wire hole 2431 may penetrate through the two sidewalls 241, and the other portion of the second wire hole 2431 may penetrate through the two end walls 243. By disposing the opening location of the second wire hole 2431 on at least one of the two sidewalls 241 or the two end walls 243 near the second end of the fixing assembly 21, the wire bundle 14 can thread out of the fixing assembly 21 as close as possible to the side where the speaker assembly 30 is located. This reduces the length of the wire bundle 14 exposed outside the fixing assembly 21, thereby reducing the influence of the wire bundle 14 on the appearance of the earphone 100. Additionally, the hole walls of the second wire hole 2431 can limit the lateral movement of the wire bundle 14, thereby limiting the wire bundle 14 at the place where the wire bundle 14 threads out of the fixing assembly 21. Therefore, the wire bundle 14 can be relatively fixed, and less prone to shift.

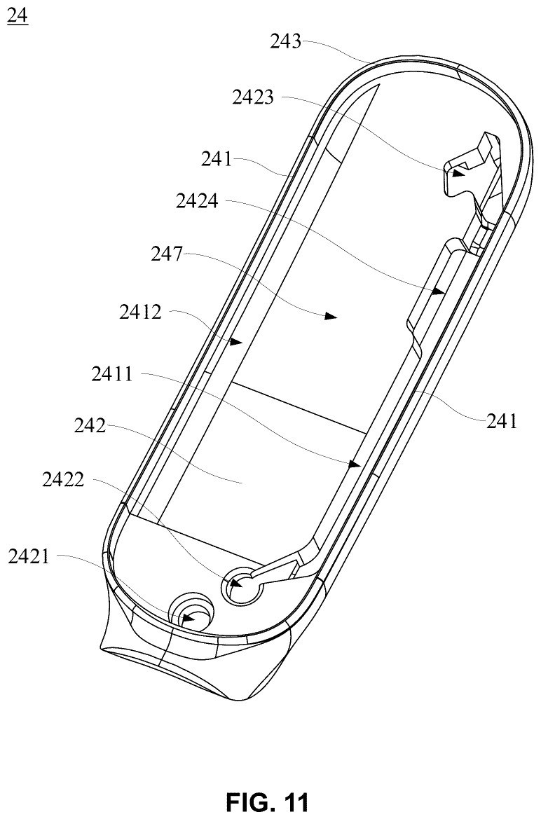

Optionally, an opening direction of the second wire hole 2431 and an extension direction of the wire groove 2411 form an angle. Generally, the telescoping member 221 is typically inserted into the telescoping cavity 231 from a middle region of the second end of the housing assembly 23, thereby enhancing the aesthetic appearance of the earphone 100. By disposing the opening direction of the second wire hole 2431 and the extension direction of the wire groove 2411 to form the angle, the location where the wire bundle 14 threads out of the fixing assembly 21 can avoid the telescoping member 221. For example, the location where the wire bundle 14 threads out may be placed on the side of the telescoping member 221. For instance, in the wearing state, the second wire hole 2431 is opened on a side of the fixing assembly 21 away from the user's face, so that the telescoping member 221 partially covers the wire bundle 14. This reduces the influence of the wire bundle 14 on the appearance of the earphone 100 after the wire bundle 14 threads out of the fixing assembly 21. When the opening direction of the second wire hole 2431 and the extension direction of the wire groove 2411 form the angle, the wire bundle 14 bends at the location where the wire bundle 14 is threaded out of the fixing assembly 21, which has a certain influence on the threading process. The first housing 24 is further provided with an outlet wire alignment groove 2423, the outlet wire alignment groove 2423 is connected to the second wire hole 2431, and an extension direction of the outlet wire alignment groove 2423 is the same as the opening direction of the second wire hole 2431. For instance, as shown in FIG. 11, the outlet wire alignment groove 2423 may be at least partially disposed in the bottom wall 242. When the wire bundle 14 is assembled, the outlet wire alignment groove 2423 may guide the wire bundle 14 into the second wire hole 2431, thereby facilitating the assembly and alignment of the wire bundle 14 and improving the assembly efficiency.

The length of the wire bundle 14 disposed out of the second end of the fixing assembly 21 is greater than a maximum elongation of the telescoping member 221, thereby preventing the telescoping member 221 from pulling the wire bundle 14 during the telescoping movement of the telescoping member 221 to improve the service life of the wire bundle 14.

Referring to FIG. 10, the fixing assembly 21 includes a first limiting member 213, the first limiting member 213 is sleeved on the wire bundle 14. For instance, the first limiting member 213 is a snap or a snap ring, and a material of the first limiting member 213 may be plastic or metal, so that the first limiting member 213 is sleeved on the wire bundle 14. Therefore, the first limiting member 213 is relatively fixed to the wire bundle 14. A place of the first housing 24 where the wire groove 2411 is opened is further provided with a wire bundle limiting groove 2424 adjacent to the second wire hole 2431, and the first limiting member 213 clamps in the wire bundle limiting groove 2424. By disposing the wire bundle limiting groove 2424, the shift of the first limiting member 213 can be limited. Since the first limiting member 213 is sleeved on the wire bundle 14 and the first limiting member 213 is fixed relative to the wire bundle 14, the wire bundle limiting groove 2424 can limit the wire bundle 14 from shifting, so that the wire bundle 14 is less prone to being pulled out of the fixing assembly 21.

Optionally, after the wire bundle 14 penetrates out of the fixing assembly 21 from the second end of the fixing assembly 21 near the speaker assembly 30, and then penetrates into the speaker assembly 30 via the end of the speaker assembly 30 connected to the telescoping member 221, the wire bundle 14 is electrically connected to the speaker assembly 30. With such arrangement, the portion of the wire bundle 14 disposed between the second end of the fixing assembly 21 near the speaker assembly 30 and the speaker assembly 30 is exposed to the air, and the portion of the wire bundle 14 is not constrained by the telescoping member 22. When the telescoping member 221 moves toward the headband assembly 10, the wire bundle 14 may have a relatively large free deformation length, which can increase a length of a bent section of the wire bundle 14 and prevent the bent section of the wire bundle 14 from being too short to affect the service life.

In an embodiment, as shown in FIG. 10, the telescoping member 221 is provided with a third wire hole 2211. The wire bundle 14 penetrates into the telescoping assembly 22 from the third wire hole 2211, and the wire bundle 14 may be hidden within the telescoping assembly 22. Under the premise of ensuring that the telescoping member 221 is freely telescoped, a length of the exposed portion of the wire bundle 14 is minimized to reduce the influence of exposing of the wire bundle 14 on the appearance of the earphone 100. Optionally, a covering body is disposed outside the telescoping member 221 to fix the wire bundle 14 to the telescoping member 221 and prevent the wire bundle 14 from being exposed outside the telescoping assembly 22. The telescoping assembly 22 further includes a second limiting member 223, the second limiting member 223 is sleeved to the wire bundle 14, and an interference between the second limiting member 223 and the third wire hole 2211 forms on a side of the third wire hole 2211 near the speaker assembly 30. The second limiting member 223 may be a snap or a snap ring, and a material of the second limiting member 223 may be plastic or metal, so that the second limiting member 223 is sleeved onto the wire bundle 14, thereby ensuring that the second limiting member 223 is relatively fixed to the wire bundle 14. Optionally, the second limiting member 223 is provided in the same form as the first limiting member 213 to reduce the type of material. By disposing the second limiting member 223 to cooperate with the third wire hole 2211, the shifting of the wire bundle 14 can be limited, so that the wire bundle 14 is not easily pulled out of the telescoping assembly 22.

To prevent the telescoping member 221 from pulling the wire bundle 14 during the telescoping movement of the telescoping member 221, the length of the wire bundle 14 disposed outside the second end of the fixing assembly 21 is greater than the maximum elongation of the telescoping member 221. When the telescoping member 221 is moved toward the headband assembly 10, the portion of the wire bundle 14 forms a bend, and an electrically conductive medium (e.g., a metal wire) inside the wire bundle 14 is bent therewith. By adjusting the distance between the speaker assembly 30 and the headband assembly 10 through the telescoping member 221, the wire bundle 14 disposed out of the second end of the fixing assembly 21 can be repeatedly bent, which leads to fatigue damage of the electrically conductive medium, such as wire breaking, thus affecting the reliability of the electrical connection between the wire bundle 14 and the speaker assembly 30.

Referring to FIG. 10, in an embodiment, the wire bundle 14 includes a plurality of wires 141 and an insulating sheath 142, the plurality of wires 141 extend from the headband assembly 10 to the speaker assembly 30. The plurality of wires 141 may include an electrically conductive medium, and a material of the insulating sheath 142 may be a material with elasticity, such as silicone or rubber. The plurality of wires 141 within the wire bundle limiting groove 2424 and on a side of the wire bundle limiting groove 2424 toward the speaker assembly 30 are covered with the insulating sheath 142. By covering the plurality of wires 141 through the insulating sheath 142, when the telescoping member 221 moves in the telescopic motion, the insulating sheath 142 is bent in synchronization with the plurality of wires 141. Due to the thickness of the insulating sheath 142, the insulating sheath 142 is located outside the plurality of wires 141. Therefore, the bent section of the wires 141 is not too short, thereby reducing the probability of the fatigue failure of the wires 141 and improving the affected service life of the plurality of wires 141. The plurality of wires 141 on the side of the wire bundle limiting groove 2424 toward the headband assembly 10 is not covered with the insulating sheath 142, thereby reducing the cross-sectional area of the wire bundle 14 and reducing the internal space of the fixing assembly 21 occupied by the wire bundle 14, thus facilitating the miniaturization of the earphone 100. Optionally, the plurality of wires 141 on the side of the wire bundle restriction groove 2424 toward the headband assembly 10 are covered with an adhesive film. A thickness of the adhesive film is significantly less than a thickness of the insulating sheath 142. For example, the thickness of the adhesive film is less than 10% of the thickness of the insulating sheath 142. The adhesive film gathers the plurality of wires 141 together to form the wire bundle 14 to facilitate the assembly of the plurality of wires 141.

In one embodiment, as shown in FIG. 7, the telescoping assembly 22 includes the telescoping member 221 and at least two damping portions 222. One end of the telescoping member 221 is slidably accommodated in the telescoping cavity 231, the other end of the telescoping member 221 is connected to the speaker assembly 30, and the at least two damping portions 222 are spaced apart on the telescoping member 221 along a circumferential direction of the telescoping member 221. Each of the at least two damping portions 222 elastically abuts against a wall of the telescoping cavity 231 in different directions. The damping portions 222 may include an elastic material, such as silicone or rubber. Each damping portion 222 may be interference-fitted with the wall of the telescoping cavity 231, causing the damping portion 222 to undergo elastic deformation. Therefore, the telescoping member 221 encounters a certain resistance when sliding within the telescoping cavity 231, allowing the user to perceive the relative sliding between the telescoping member 221 and the fixing assembly 21, and enhancing a tactile sense when the distance between the speaker assembly 30 and the headband assembly 10 is adjusted via the telescoping member 221. The at least two damping portions 222 are spaced apart on the telescoping member 221 along the circumferential direction of the telescoping member 221. Each of the at least two damping portions 222 elastically abuts against the wall of the telescoping cavity 231 in different directions, so that an outer periphery of the telescoping member 221 and a cavity wall of the telescoping cavity 231 form at least two contact points. The cavity wall forms at least two supporting forces on the telescoping member 221, and directions of the at least two supporting forces are different. The cavity wall forms a multi-point support to the telescoping member 221, thereby improving the uniformity of the force on the telescoping member 221 when sliding within the telescoping cavity 231, and reducing the likelihood of jamming during the telescoping travel. Additionally, the distance adjustment between the speaker assembly 30 and the headband assembly 10 can be relatively smooth.

Optionally, a setting count of the damping portions 222 is 2, 3, or 4, which is not specifically limited herein. The greater the setting count of the damping portions 222 is, the more supporting forces the cavity wall form on the telescoping member 221. The directions of the supporting forces are different, so that the cavity wall provides the multi-point support to the telescoping member 221. Therefore, the support points are more evenly distributed around the outer periphery of the telescoping member 221, and the forces acting on the telescoping member 221 are more uniform when the telescoping member 221 slides within the telescoping cavity 231.

Optionally, as shown in FIG. 8, the setting count of the damping portions 222 is two, and the damping portions 222 include a first damping portion 222a and a second damping portion 222b. By disposing the setting count of the damping portions 222 as 2, the forces on the telescoping member 221 can be more uniform when the telescoping member 221 slides within the telescoping cavity 231, and the processing difficulty of the telescoping assembly 22 can be reduced. The first damping portion 222a and the second damping portion 222b protrude from opposite sides of the telescoping member 221, respectively, and an extension direction of the first damping portion 222a is opposite to an extension direction of the second damping portion 222b, so that the supporting forces formed by the first damping portion 222a and the second damping portion 222b are located on both sides of the telescoping member 221, respectively. As a result, the forces acting on the telescoping member 221 are symmetrical when the telescoping member 221 slides within the telescoping cavity 231, thereby reducing the likelihood of jamming during the telescoping travel.

Optionally, the housing assembly 23 is a one-piece structure. For example, the housing assembly 23 is integrally formed through the injection molding process, and the telescoping cavity 231 is formed within the housing assembly 23. The one-piece structure of the housing assembly 23 has the better integrity, and the cavity wall of the telescoping cavity 231 may be relatively smooth, which is convenient to cooperate with the damping portions 222. The extension direction of the damping portions 222 is less restricted.

In an embodiment, as shown in FIG. 7 and FIG. 8, the housing assembly 23 includes the first housing 24 and the second housing 25, and the first housing 24 and the second housing 25 enclose to form the telescoping cavity 231. By disposing the housing assembly 23 as the split type, the telescoping cavity 231 is formed by enclosing the first housing 24 and the second housing 25. Therefore, the telescoping cavity 231 is formed by enclosing the open groove, thereby reducing the manufacturing difficulty of the housing assembly 23 with respect to integrally forming the housing assembly 23. One of the first housing 24 and the second housing 25 is disposed close to the user's head in the wearing state, and the other one of the first housing 24 and the second housing 25 is disposed away from the user's head. When the first housing 24 and the second housing 25 enclose to form the telescoping cavity 231, the splicing seam between the first housing 24 and the second housing 25 avoids the side of the fixing assembly 21 that contacts the user's head. For example, the splicing seam between the first housing 24 and the second housing 25 may be located on the side of the fixing assembly 21 near the top of the head and the side near the chin, thereby improving the wearing comfort of the earphone 100.

Further, the first damping portion 222a and the second damping portion 222b elastically abut against the first housing 24 and the second housing 25, respectively. Specifically, the first damping portion 222a may elastically abut against one of the first housing 24 and the second housing 25, and the second damping portion 222b may elastically abut against the other one of the first housing 24 and the second housing 25. The splicing seam between the first housing 24 and the second housing 25 may be located on the side of the fixing assembly 21 near the top of the head and the side near the chin, thereby improving the wearing comfort of the earphone 100. By disposing the first damping portion 222a and the second damping portion 222b to elastically abut against the first housing 24 and the second housing 25, respectively, the splicing scam between the first housing 24 and the second housing 25 can be avoided when the damping portion 222 abuts against the cavity wall of the telescoping cavity 231, thereby preventing the unevenness of the splicing seam from causing uneven forces on the telescoping member 221 when the telescoping member 221 slides within the telescoping cavity 231.

Optionally, the damping portions 222 are integrally molded in the telescoping member 221. For example, at least two protrusions are disposed at intervals along the circumferential direction of the telescoping member 221, and the at least two protrusions are covered with an elastic material, such as silicone or rubber, thereby forming the damping portions 222. Alternatively, the protrusions are coated with a glue or a coating to form the damping portions 222. By integrally molding the damping portions 222 and the telescoping member 221, the telescoping assembly 22 has better integrity.

Optionally, the damping portions 222 and the telescoping member 221 are manufactured, respectively, and then assembled and connected. By disposing the damping portions 222 and the telescoping member 221 as the split type, the damping portions 222 and the telescoping member 221 may be processed and molded with different materials, respectively. For example, the damping portions 222 are made of the elastic material with relatively low hardness, such as silicone or rubber, so that the damping portions 222 have a certain degree of elasticity, thereby improving the tactile sense of the telescoping member 221 when the distance between the speaker assembly 30 and the headband assembly 10 is adjusted. Accordingly, the telescoping member 221 may be made of a material with relatively high hardness, such as plastic or metal, so that the telescoping member 221 has a relatively high strength, thereby improving the service life of the telescoping member 221.

Optionally, the damping portions 222 are attached to the telescoping member 221 in a bonding manner. Alternatively, the telescoping member 221 is opened with at least one mounting hole 2212, and the first damping portion 222a and the second damping portion 222b are inserted in the at least one mounting hole 2212 in an interference fit manner, as shown in FIG. 8. Specifically, a count of the at least one mounting hole 2212 may be two, each of opposite sides of the telescoping member 221 is opened with one mounting hole 2212, and each mounting hole 2212 is mounted with one damping portion 222. The mounting holes 2212 may be through holes or blind holes. Alternatively, the count of the at least one mounting hole 2212 is one, and the mounting hole 2212 penetrates through the opposite sides of the telescoping member 221. The first damping portion 222a and the second damping portion 222b are inserted in two opposite openings of the mounting hole 2212 in the interference fit manner, respectively, so that the first damping portion 222a and the second damping portion 222b protrude on the opposite sides of the telescoping member 221, respectively. By opening the at least one mounting hole 2212 in the telescoping member 221 for mounting the damping portions 222, the damping portion 222 can be mounted by being inserted in the mounting holes 2212. On the one hand, the at least one mounting hole 2212 can be used to position the damping portions 222 during the assembly, facilitating the installation of the damping portions 222. On the other hand, after the damping portions 222 are assembled into the at least one mounting hole 2212, hole wall(s) of the at least one mounting hole 2212 can also fix the damping portions 222. The damping portions 222 can be connected to the telescoping member 221 without gluing, making the assembly more convenient and faster.

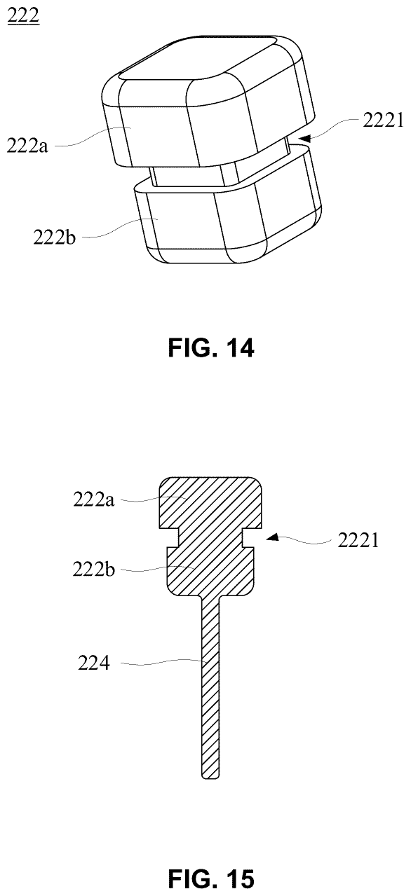

In an embodiment, as shown in FIG. 8 and FIG. 14, the count of the at least one mounting hole 2212 is one, and the mounting hole connects the opposite sides of the telescoping member 221. The first damping portion 222a and the second damping portion 222b are connected to each other to form a one-piece member. The one-piece member is inserted in the mounting hole 2212 in the interference fit manner. By disposing the first damping portion 222a and the second damping portion 222b to form the one-piece member, the first damping portion 222a and the second damping portion 222b can be integrally molded, facilitating the manufacturing of the first damping portion 222a and the second damping portion 222b, simplifying the manufacturing process of the damping portions 222, and enhancing the integrity of the damping portions 222.

Optionally, in a reference section perpendicular to an axial direction of the mounting hole 2212, a cross-sectional dimension of the first damping portion 222a is greater than a cross-sectional dimension of the second damping portion 222b. Accordingly, a cross-sectional dimension of an end of the mounting hole 2212 where the first damping portion 222a is inserted is larger than a cross-sectional dimension of an end of the mounting hole 2212 where the second damping portion 222b is inserted. When the damping portions 222 are mounted, on the one hand, a mounting direction of the damping portions 222 may be quickly identified through differences in the cross-sectional dimensions, thereby improving the assembly efficiency. On the other hand, the second damping portion 222b, which has the relatively small cross-sectional dimension, may first be placed into one end of the mounting hole 2212 to insert the first damping portion 222a, and the hole wall of the mounting hole 2212 has a small resistance to the second damping portion 222b, facilitating the loading of the damping portions 222, thereby further improving the assembly efficiency.

Optionally, as shown in FIG. 15, the telescoping assembly 22 further includes a pulling portion 224 connected to the second damping portion 222b. In the reference section perpendicular to the axial direction of the mounting hole 2212, a cross-sectional dimension of the pulling portion 224 is smaller than a cross-sectional dimension of the mounting hole 2212. The pulling portion 224 is used to assist in mounting the one-piece member. For example, the pulling portion 224 may be integrally molded to the second damping portion 222b, and a shape of the pulling portion 224 may be an elongated strip, such as a band, so that the pulling portion 224 is gripped and dragged to move the one-piece member into the mounting hole 2212, and the pulling portion 224 may be removed after the one-piece member is mounted relative to the mounting hole 2212. Alternatively, the pulling portion 224 is provided with an opening hole or a groove, and a pull cord or hook may be threaded (or sleeved) through the opening hole or the groove. By holding the pull cord or hook, the one-piece member may be dragged into the mounting hole 2212. After the one-piece member is mounted relative to the mounting hole 2212, the pull cord or hook may be removed, and the pulling portion 224 may be remained in the second damping portion 222b. By disposing the pulling portion 224 to be used to assist in mounting the one-piece member, the assembly efficiency can be improved.

Referring to FIG. 8, FIG. 14, and FIG. 15, in an embodiment, the one-piece member is opened with a limiting groove 2221 along a circumferential direction of the mounting hole 2212, and an inner wall of the mounting hole 2212 is provided with a second limiting flange 226 along the circumferential direction of the mounting hole 2212. The second limiting flange 226 is embedded in the limiting groove 2221 to limit the one-piece member along the axial direction of the mounting hole 2212, so that the one-piece member is not easily fallen out of the mounting hole 2212, thereby improving the connection between the one-piece member and the telescoping member 221.

A section of a portion of the telescoping member 221 accommodated within the telescoping cavity 231 perpendicular to the telescoping direction may be a circular, oval, or polygonal. Optionally, the portion of the telescoping member 221 accommodated within the telescoping cavity 231 has a thickness direction and a width direction. A dimension of the portion in the width direction is greater than a dimension of the portion in the thickness direction, and a shape of the section of the portion perpendicular to the telescoping direction may be a rectangular shape. The mounting hole 2212 is connected to the opposite sides of the telescoping member 221 along the thickness direction. By disposing the mounting hole 2212 along the thickness direction of the telescoping member 221, and having the dimension in the width direction greater than the dimension in the thickness direction, an opening area of the mounting hole 2212 can be relatively large, thereby accommodating the damping portions 222 with a relatively large dimension. Therefore, a contact area between the damping portions 222 and the cavity wall of the telescoping cavity 231 can be increased, thereby improving the uniformity of the force when the telescoping member 221 slides within the telescoping cavity 231, and reducing the possibility of jamming during the telescoping travel.

Optionally, as shown in FIG. 8, an end of the telescoping member 221 away from the speaker assembly 30 is provided with a limiting protrusion 225. The limiting protrusion 225 is configured to limit the telescoping member 221 from sliding out of the telescoping cavity 231, and the mounting hole 2212 is opened on the limiting protrusion 225. With such arrangement, on the one hand, the limiting protrusion 225 can cooperate with the cavity wall of the telescoping cavity 231 to limit the maximum telescoping travel when the telescoping member 221 slides toward the speaker assembly 30, thereby preventing the telescoping member 221 from sliding out of the telescoping cavity 231. On the other hand, the mounting hole 2212 is opened on the limiting protrusion 225 to form the reinforcement at a place where the mounting hole 2212 is opened, reducing the weakening effect caused by the opening of the mounting hole 2212 on the telescoping member 221 and preventing the failure of the telescoping member 221 at the place where the mounting hole 2212 is opened. Additionally, the limiting protrusion 225 partially protrudes from the telescoping member 221, and the mounting hole 2212 is opened on the limiting protrusion 225. When the one-piece member is inserted into the mounting hole 2212, the limiting protrusion 225 wraps around an outer periphery of the damping portions 222, forming a protective shell for the damping portions 222. Therefore, the outer periphery of the damping portions 222 does not contact with the end wall of the telescoping cavity 231 at the maximum telescoping travel of the telescoping member 221, thereby improving the service life of the damping portions 222.

The above descriptions are only a portion of embodiments of the present disclosure, and are not intended to limit the scope of the present disclosure. Any equivalent device or equivalent process transformed using the contents of the specification of the present disclosure and the accompanying drawings, or directly or indirectly applied in other related technical fields, are all included in the scope of the present disclosure.

1-10. (canceled)

11. An earphone, comprising:
a headband assembly, a connecting assembly, and a speaker assembly, wherein
the headband assembly is disposed around a periphery of a top of a use's head in a wearing state and provides a clamping force, and the connecting assembly is connected between the headband assembly and the speaker assembly;
the connecting assembly includes a fixing assembly and a telescoping assembly, wherein
the fixing assembly is connected to the headband assembly,
the telescoping assembly includes a telescoping member, one end of the telescoping member is connected to the fixing assembly telescopically, and the other end of the telescoping member is connected to the speaker assembly;
the headband assembly includes a wire bundle, wherein the wire bundle penetrates into the fixing assembly from a first end of the fixing assembly near the headband assembly, and penetrates out the fixing assembly from a second end of the fixing assembly near the speaker assembly, the wire bundle being electrically connected to the speaker assembly;
the fixing assembly is provided with a telescoping cavity, one end of the telescoping member is slidably accommodated within the telescoping cavity, the wire bundle is disposed outside the telescoping cavity.

12. The earphone of claim 11,
the fixing assembly includes a first housing and a fitting member, the first housing encloses to form at least a portion of the telescoping cavity, and a portion of the wire bundle located between the first end and the second end of the fixing assembly is configured to be visible from an exterior of the first housing and is covered by a contact member.

13. The earphone of claim 12, wherein
one side of the first housing is provided with a first telescoping groove, and the other side of the first housing away from the first telescoping groove is provided with a wire groove,
the wire bundle is embedded within the wire groove, and the contact member covers the wire groove.

14. The earphone of claim 12, in the wearing state, the contact member is disposed on a side of the first housing near the head, and is configured to abut against a side surface of the head to achieve an auxiliary positioning of the headband assembly on the head.

15. The earphone of claim 13, wherein the first housing has a first vertical direction and a second vertical direction, the first vertical direction is perpendicular to the telescoping direction of the telescoping member, and the second vertical direction is perpendicular to the telescoping direction and the first vertical direction,
the first housing includes two sidewalls spaced apart from each other along the first vertical direction and a bottom wall connecting the two sidewalls along the first vertical direction, a thickness of each of the two sidewalls along the second vertical direction being greater than a thickness of the bottom wall along the second vertical direction so as to form the first telescoping groove between the two sidewalls,
at least a portion of a projection of the wire groove along the second vertical direction falls within one of the two sidewalls.

16. The earphone of claim 15, wherein the wire groove and a projection of the first telescoping groove along the first vertical direction at least partially overlap.

17. The earphone of claim 15, wherein the other side of the first housing away from the first telescoping groove is further provided with a glue reduction groove, and at least a portion of a projection of the glue reduction groove along the second vertical direction falls within the other one of the two sidewalls.

18. The earphone of claim 17, along the telescoping direction, each of a length of the wire groove and a length of the glue reduction groove is not less than 50% of a length of the two sidewalls;
a length of the portion of the wire groove falling within the one of the two sidewalls is not less than 50% of the length of the wire groove, and a length of the portion of the glue reduction groove falling within the other one of the two sidewalls is not less than 50% of the length of the glue reduction groove.

19. The earphone of claim 17, wherein the fixing assembly further includes a second housing cooperating with the first housing,
the first housing and/or the second housing is provided with a plugging hole plugging with the headband assembly, the wire bundle is inserted into a space enclosed by the first housing and the second housing along the plugging hole,
the first housing is further provided with a first wire hole near the first end of the fixing assembly and connected to the wire groove, and the wire bundle further extends through the first wire hole to the other side of the first housing away from the first telescoping groove.

20. The earphone of claim 19, wherein the first housing includes two end walls spacing apart from each other along the telescoping direction and connecting the two sidewalls,
the first housing is provided with a second wire hole near the second end of the fixing assembly and connected to the wire groove, the second wire hole penetrates through the two sidewalls and/or the end walls near the second end of the fixing assembly, and the wire bundle extends through the second wire hole toward the speaker assembly.

21. The earphone of claim 20, wherein an opening direction of the second wire hole and an extension direction of the wire groove form an angle,
the first housing is provided with an outlet wire alignment groove, the outlet wire alignment groove is connected to the second wire hole, and an extension direction of the outlet wire alignment groove is the same as the opening direction of the second wire hole.

22. The earphone of claim 21, wherein the fixing assembly includes a first limiting member, the first limiting member is sleeved on the wire bundle,
a place of the first housing where the wire groove is opened is further provided with a wire bundle limiting groove adjacent to the second wire hole, and the first limiting member clamps in the wire bundle limiting groove.

23. The earphone of claim 22, wherein
the telescoping member is provided with a third wire hole,
the telescoping assembly further includes a second limiting member, the second limiting member is sleeved to the wire bundle, and an interference between the second limiting member and the third wire hole forms on a side of the third wire hole near the speaker assembly.

24. The earphone of claim 23, wherein the wire bundle includes a plurality of wires and an insulating sheath,
the plurality of wires extend from the headband assembly to the speaker assembly, a portion of the plurality of wires within the wire bundle limiting groove and a portion of the plurality of wires in a side of the wire bundle limiting groove facing the speaker assembly are covered with the insulating sheath, and a portion of the plurality of wires in a side of the wire bundle limiting groove facing the headband assembly are not covered with the insulating sheath.

25-34. (canceled)

35. The earphone of claim 11, wherein the fixing assembly is provided with a telescoping cavity, the wire bundle penetrates into the telescoping cavity from the first end of the fixing assembly near the headband assembly, and penetrates out the telescoping cavity from the second end of the fixing assembly near the speaker assembly, the telescoping cavity is provided with an isolation member to isolate the telescoping member from the wire bundle.

36. The earphone of claim 19, wherein the first wire hole is opened on the bottom wall, and the first wire hole penetrates through two oppositely disposed surfaces of the bottom wall along the second vertical direction.

37. The earphone of claim 21, wherein the second wire hole is opened on a side of the fixing assembly away from the user's face, the telescoping member partially covers the wire bundle in the wearing state.

38. The earphone of claim 21, wherein the outlet wire alignment groove is at least partially disposed in the bottom wall, when the wire bundle is assembled, the outlet wire alignment groove guides the wire bundle into the second wire hole.

39. The earphone of claim 23, wherein the wire bundle penetrates into the telescoping assembly from the third wire hole, a covering body is disposed outside the telescoping member to fix the wire bundle to the telescoping member and prevent the wire bundle from being exposed outside the telescoping assembly.

40. The earphone of claim 11, wherein a length of the wire bundle disposed out of the second end of the fixing assembly is greater than a maximum elongation of the telescoping member.
